(19) United States
(12) Patent Application Publication
(10) Pub. No.: US 2009/0192237 A1
(43) Pub. Date: Jul. 30, 2009

(54) Low scorching flame retardants for polyurethane foams

(75) Inventors: Barbara A. Williams, New York, NY (US); Edward D. Weil, New York, NY (US); Gerald Fesman, Port Hueneme, CA (US); Theodore Halchak, Upper Montclair, NJ (US); Danielle A. Bright, New City, NY (US); Alyce Halchak, Upper Montclair, NY (US); Leslie Bright, New City, NY (US)

Correspondence Address: DILWORTH & BARRESE, LLP, 1000 WOODBURY ROAD, SUITE 405, WOODBURY, NY, 11797, US

(73) Assignee: SUPRESTA LLC, Ardsley, NY (US)

(21) Appl. No.: 11/587,618

(22) PCT Filed: Apr. 26, 2005
(86) PCT No.: PCT/US2005/014166

§ 371 Date: Jan. 17, 2008

Related U.S. Application Data
(60) Provisional application No. 60/565,859, filed on Apr. 27, 2004.

(51) Int. Cl. C09K 21/12; C08G 18/82

(52) U.S. Cl. 521/170; 252/609

(57) ABSTRACT

A flame retardant composition for use in flame retarding a polyurethane foam composition so that the foam has reduced scorch as a result of its manufacture, said flame retardant composition comprising a mixture of (a) a flame retardant of the type that normally causes scorch when used in such foam and (b) a benzofuranone derivative, as a anti-scorch stabilizer. Flame retarded polyurethane foams having reduced discoloration are also provided.

### CROSS REFERENCE TO RELATED APPLICATIONS

This application claims the benefit of Provisional U.S. Patent Application Ser. No. 60/565,859, filed Apr. 27, 2004, the entire contents of which are incorporated by reference herein.

### BACKGROUND OF THE INVENTION

The present invention relates to the combination of a flame retardant and a lactone stabilizer in a flame retardant additive formulation that, when incorporated into a polyurethane foam, results in a considerable reduction in the discoloration (also referred to as “scorch”) of that polyurethane foam as compared to when only the flame retardant component is employed.

Polyurethane foams are made by the reaction (or polymerization) of aromatic isocyanates and aliphatic polyols. The process involves the simultaneous polymerization of these reagents and the expansion of the resulting polymer by blowing agents, such as chlorofluorocarbons (CFC's). Because this process is highly exothermic, it often causes the development of scorch, which is an undesirable discoloration in the center of the flexible polyurethane foam bun. Efforts to reduce the use of CFC blowing agents for foaming by increasing the water content leads to even higher exotherms and therefore increased scorch generation. In addition to the reduction of the foam's aesthetic value, scorch adversely affects key physical properties such as tensile and tear strength, elongation and compression set.

During commercial flexible polyurethane foam processing, such scorching may occur in the center of the foam buns. This scorching is usually observed when the bun is cut open about one hour after reaching its maximum exotherm. The propensity to scorch escalates with increasing exotherm temperature, which, in turn, is dependent on the water level used in the formulation. As the water level is increased from, for example, 3.5 to 5.0 parts per hundred polyol (php), the exotherm may increase from 130° C. to 170° C. (foam line temperature). The susceptibility for scorching of the foam bun is increased by the addition of certain flame retardants, for example, certain haloalkyl phosphates and certain brominated flame retardants, as well as others, into the formulation.

Therefore, combining a high water level with a flame retardant in the foam formulation can more readily promote scorching. A 3.5 php water level is less likely to induce scorch even with a flame retardant present. A water level of 5.0 php plus flame retardant is very likely to produce scorch.

Scorch that usually occurs at the center of the foam is most likely to occur in slabstock foams. Due to the low thermal conductivity of flexible foams, the heat is likely to disperse slowly. This seems to happen more readily in high water formulations and with the use of auxiliary blowing agents.

To assess the scorch potential of various flame-retardants, a laboratory scale test that correlates well with actual foam production is the use of microwave radiant energy, as described in U.S. Pat. No. 4,131,660. This microwave oven test heats the flexible polyurethane foam and thereby increases the internal temperature with microwave radiant energy.

As described before, the addition of certain flame retardants increases the level of scorch produced in the foam. A number of approaches have been used to reduce discoloration. In U.S. Pat. No. 5,182,193, (Dow Chemical) hindered phenolic antioxidants are described for that purpose. U.S. Pat. No. 5,422,415 (Ciba Geigy Corp.) describes the use of a combination of a benzofuranone additive, an amine anti-oxidant and/or a hindered phenolic. Vitamin E (alpha or beta tocopherol) together with octyl diphenyl amine is described for use by Bayer in U.S. Pat. No. 5,695,689. U.S. Pat. No. 5,130,360 (Rhein Chemie Rheinau) claims the use of an aromatic carbodiimide and a benzohydroquinone to prevent polyester urethane discoloration and to reduce hydrolytic degradation. U.S. Pat. No. 5,869,565 (Ciba Specialty Chemicals) describes the combination of polyether polyol(s), a benzofuranone derivative, and at least one phenolic antioxidant and/or at least one secondary amine type antioxidant. All these approaches result in an improvement in the appearance of the foam.

### BRIEF SUMMARY OF THE INVENTION

The present invention relates to a flame retardant composition for use in flame retarding a polyurethane foam composition so that the foam has reduced scorch as a result of its manufacture. The invention involves the use of a flame retardant composition which comprises a combination of a flame retardant component, of the type that normally gives rise to scorching problems, and a benzofuranone derivative (of the type described in previously mentioned U.S. Pat. No. 5,869,565).

The polyurethane foams prepared with the flame retardant composition of the present invention have considerably reduced discoloration (scorch) compared with foams which utilize only the flame retardant component. In accordance with the present invention, it is unnecessary to employ the antioxidants, such as phenolics and amines, disclosed in the prior art in order to obtain the considerable reduction in discoloration achieved herein.

### DETAILED DESCRIPTION

The benzofuranone derivatives useful in the practice of the present invention include those having the formula:

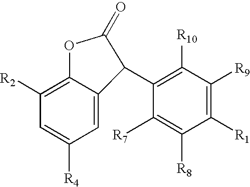

wherein either

two of R₁, R₇, R₈, R₉ and R₁₀ are each independently of the other C₁-C₄ alkyl, the others being hydrogen, or

R₇ to R₁₀ are hydrogen, or at most two of these radicals are each independently of the other methyl, and R₁ is

—O—CHR₃—CHR₅—OCO—R₆,

R₂ and R₄ are each independently of the other hydrogen or C₁-C₆ alkyl,

R₃ is hydrogen or C₁-C₄ alkyl,

R₅ is hydrogen, phenyl or C₁-C₆ alkyl, and

R₆ is C₁-C₄ alkyl.

Specific compounds within the above formula include 5,7-di-t-butyl-3-(3,4 dimethylphenyl)3H-benzofuranone-2-one, which is also preferred herein.

The amount of benzofuranone derivative that is used to accomplish the objectives of the present invention may vary, for example, from about 0.05% to about 5% by weight, based on the total weight of flame-retardant component. Preferably, the benzofuranone derivative is employed at about 1% by weight, based on the total weight of flame retardant component.

Examples of flame retardants for use in the practice of the present invention include, for example, haloalkyl phosphates, including chloroalkyl phosphate esters, such as tris(dichloroisopropyl) phosphate, e.g., tris(1,3-dichloroisopropyl) phosphate, and tris(chloropropyl phosphate), oligomeric chloroalkyl phosphates (such as AB 100 brand from Rhodia) and the like and oligomeric alkyl phosphates. These materials can be employed alone or in combination with triaryl phosphates, such as butylated triphenyl phosphate, isopropyl triphenyl phosphate and the like and/or with oligomeric aryl phosphates, such as resorcinol bis(diphenyl phosphate), bisphenol A bis(diphenyl phosphate), neopentylglycol bis(diphenyl phosphate) and the like and/or with haloalkyl phosphates.

A second category of halogenated flame retardant for use herein are the brominated flame retardants. They include brominated aryl esters, such as esters of tetrabromobenzoic acid. These materials can be employed alone or in combination with triaryl phosphates (such as the propylated, butylated triphenyl phosphates), and the like and/or with oligomeric aryl phosphates, such as, resorcinol bis(diphenyl phosphate), bisphenol A bis(diphenyl phosphate), neopentylgylcol bis(diphenyl phosphate), and the like. This class of brominated materials also include brominated alkyl products, such as dibromoneopentyl glycol, tribromoeopentyl alcohol and the like. These materials can be employed alone or in combination with triaryl phosphates (propylated, butylated triphenyl phosphates) and the like and/or with oligomeric aryl phosphates, such as, resorcinol bis(diphenyl phosphate), bisphenol A bis((diphenyl phosphate), neopentylglycol bis(diphenyl phosphate) and the like).

Amounts of flame retardant used in the practice of the present invention may vary, but typically include amounts ranging from about 3 to about 30 parts per 100 parts of polyol, preferably from about 7 to about 20 parts per 100 parts of polyol, used in the preparation of the polyurethane foam.

This invention is further illustrated in the following representative Examples:

### EXAMPLES

### Polyurethane Foam Production

The polyol, flame-retardant, water, amine catalysts and silicone were mixed with stirring, in a first beaker. In a separate beaker, the toluene diisocyanate (TDI) was weighed out. The organo-tin catalyst was put into a syringe. The first beaker was stirred at about 2100 revolutions per minute for a period of ten seconds and then the organo-tin catalyst was dosed thereto while stirring was continued. After a total of twenty-one seconds of stirring, the TDI was added to the mixture. Stirring was then continued for an additional nine seconds, and the still fluid mixture was quickly put into an 8″×8″×5″ box. Then the cream and rise times were measured. Once the foam ceased to rise, it was placed in a microwave oven for eighty seconds.

| Formulation | Parts |
|---|---|
| polyether polyol (ARCO) | 100 |
| Fyrol ® FR-2 + 1% HP-136 | 14 |
| Dabco 3 3LV/A-1 3:1 amine | 0.22 |
| Catalyst (Air Products) | |
| H₂0 | 5.00 |
| L620 silicone (Urethane Additives) | 1.00 |
| Stannous octoate T-10 (Air Products) | 0.35 |
| Toluene diisocyanate TDI (Bayer) | 60 |
| NCO index | 110 |

HP-136 brand stabilizer, available from Ciba Specialty Chemicals, is 5,7-di-t-butyl-3-(3,4 dimethylphenyl) 3H-benzofuran-2-one (CAS Number of 181314-48-7).
Fyrol ® FR-2 brand flame retardant, available from Supresta LLC, is tris(1,3-dichloroisopropyl) phosphate.

### Test Methods:

### Microwave Oven Test

The amount of discoloration in the foam called scorch was measured according to “A Rapid Predictive Test for Urethane Foam Scorch” Journal of Cellular Plastics September/October 1978. This method employs a microwave oven as a tool to cure and heat the inner core of the polyurethane foam. The foams were formulated at high water levels (5 php). This method has been said to be equivalent to large slabstock foams. After the foams were cooled, they were cut in the center, and the discoloration was assessed visually. The visual rating represents a number from 1 to 5. A value of 1 is assigned to a white foam showing no discoloration, whereas a value of 5 would represent a very dark foam.

| | Level of flame retardant | Visual |
|---|---|---|
| Foam Sample | composition (Parts) | Rating |
| No flame retardant | 0 | 1.0 |
| Fyrol ® FR-2 + 1% HP-136 | 14 | 1.5 |
| Fyrol ® FR-2 alone | 14 | 3.0 |

The above data show the improved results obtained by the present invention.

The foregoing examples merely illustrate certain embodiments of the present invention and for that reason should not be construed in a limiting sense. The scope of protection that is sought is set forth in the claims that follow.

What is claimed is:

1. A flame retardant composition for use in flame retarding a polyurethane foam composition so that the foam has reduced scorch as a result of its manufacture, said flame retardant composition comprising a mixture of (a) a flame retardant of the type that normally causes scorch when used in such foam and (b) a benzofuranone derivative, as a anti-scorch stabilizer.

2. The composition of claim 1 wherein the flame retardant is a haloalkyl phosphate.

3. The composition of claim 2 wherein the haloalkyl phosphate is a chloroalkyl phosphate.

4. The composition of claim 3 wherein the chloroalkyl phosphate is tris(1,3-dichloroispropyl) phosphate.

5. The composition of claim 1 wherein the flame retardant is a blend of flame retardants.

6. The composition of claim 5 wherein the blend of flame retardants is selected from the group consisting of a blend of haloalkyl phosphate and triaryl phosphate and haloalkyl phosphate and oligomeric aryl phosphates.

7. The composition of claim 1 wherein the flame retardant is a brominated flame retardant.

8. The composition of claim 7 wherein the brominated flame retardant is an ester of tetrabromobenzoic acid.

9. The composition of claim 7 wherein the flame retardant is a blend of flame retardants.

10. The composition of claim 9 wherein the blend of flame retardants is selected from the group consisting of a blend of a brominated flame retardant and a triaryl phosphate and a blend of a brominated flame retardant and an oligomeric aryl ester.

11. The composition of claim 1 wherein the benzofuranone derivative is a compound having the formula 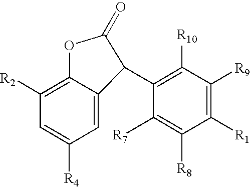
wherein either
two of R₁, R₇, R₈, R₉ and R₁₀ are each independently of the other C₁-C₄ alkyl, the others being hydrogen, or
R₇ to R₁₀ are hydrogen, or at most two of these radicals are each independently of the other methyl, and R₁ is
—O—CHR₃—CHR₅—O—CO—R₆,
R₂ and R₄ are each independently of the other hydrogen or C₁-C₆ alkyl,
R₃ is hydrogen or C₁-C₄ alkyl,
R₅ is hydrogen, phenyl or C₁-C₆ alkyl, and
R₆ is C₁-C₄ alkyl.

12. The composition of claim 11 wherein the benzofuranone compound is 5,7-di-t-butyl-3-(3,4-dimethylphenyl)3H-benzofuranone-2-one.

13. A flame retarded polyurethane foam composition having reduced scorch comprising said foam, a flame retardant of the type that normally causes scorch and a benzofuranone derivative, as an anti-scorch stabilizer.

14. The composition of claim 13 wherein the flame retardant is a haloalkyl phosphate.

15. The composition of claim 14 wherein the haloalkyl phosphate is tris(1,3-chloroisopropyl) phosphate.

16. The composition of claim 13 wherein the flame retardant is a brominated flame retardant.

17. The composition of claim 16 wherein the brominated flame retardant is an ester of tetrabromobenzoic acid.
